(19) United States
(12) Patent Application Publication
(10) Pub. No.: US 2020/0284875 A1
(43) Pub. Date: Sep. 10, 2020

(54) VEHICLE RADAR DETECTION ANGLE ADJUSTMENT SYSTEM AND ANGULARLY ADJUSTABLE RADAR THEREOF

(71) Applicant: CUBTEK INC., Zhubei City (TW)

(72) Inventors: SAN-CHUAN YU, Zhubei City (TW); SHYH-JONG CHUNG, Zhubei City (TW); CHING-HAN TSAI, Zhubei City (TW); CHUAN-TING KUO, Zhubei City (TW); BO-YI WANG, Zhubei City (TW); TZU-CHUAN HUANG, Zhubei City (TW)

(21) Appl. No.: 16/439,066

(22) Filed: Jun. 12, 2019

(30) Foreign Application Priority Data
Mar. 6, 2019 (TW) 108107334

(51) Int. Cl. G01S 7/40; G01S 13/93; H01Q 1/32

(52) U.S. Cl. CPC G01S 7/4008; G01S 2013/9392; H01Q 1/3233; G01S 13/931

(57) ABSTRACT

A vehicle radar detection angle adjustment system and angularly adjustable radar thereof are provided. The system comprises a transmission unit, a processing unit, and a receiving unit. The transmission unit generates a radar beam according to an operation frequency. The processing unit, by the adjustment of the operation frequency, changes a dip angle of the transmission of the radar beam from the transmission unit, and generates a feedback signal after receiving the radar beam through the receiving unit. The processing unit is electrically connected with the receiving unit for receiving the feedback signal, so as to compare the beam frequency of the received feedback signal, and select an operation frequency corresponding to the radar beam having the predetermined energy. Therefore, the radar beam is launched at an optimal angle.

### BACKGROUND OF THE INVENTION

### 1. Field of the Invention

The present invention relates to radar detection systems, and more particularly, to a vehicle radar detection angle adjustment system and angularly adjustable radar thereof.

### 2. Description of the Related Art

A conventional vehicle radar detection system is a radar transmitter disposed on the in-vehicle rearview mirror. Bye use of the radar transmitter launching out a radar beam, the status of the vehicle ahead is detected, such as the speed and distance of the vehicles ahead. However, the radar beam launched out by such radar transmitter will be refracted when passing through the windshield (especially those being attached with window films having a small amount of metal), such that the dip angle of the radar beam is varied, and the radar beam is unable to be launched out at an optimal angle (such as in parallel to the ground surface). As a result, the vehicle detection is sometimes not reliable. Therefore, the dip angle of the radar beam transmission needs to be calibrated.

Referring to U.S. Pat. No. 5,313,213A, a conventional vehicle radar detection system is disclosed, wherein a mechanical adjustment is applied (such as providing an adjustment screw) for adjusting the dip angle of the radar beam transmission. However, mechanical adjustment has to be repeatedly operated for acquiring the correct dip angle. Although the dip angle of the radar beam transmission is correctly adjusted, the calibration process is slow due to the repeatedly carried out adjustment, lowering the efficiency of the calibration process. Therefore, it is desirable to resolve such issue.

### SUMMARY OF THE INVENTION

For improving the issues above, a vehicle radar detection angle adjustment system and the angularly adjustable radar thereof are disclosed. When the refraction of the radar beam occurs during the radar beam passing through a medium (such as the windshield), the operation frequencies are adjusted within a frequency range, and different feedback signals are received and compared, so as to select the operation frequency of a predetermined energy, whereby the dip angle of the radar beam is calibrated.

For achieving the aforementioned objectives, a vehicle radar detection angle adjustment system in accordance with an embodiment of the present invention comprises a processing unit, a transmission unit, and a receiving unit. The transmission unit is electrically connected with the processing unit. The transmission unit generates a radar beam according to an operation frequency. The processing unit adjusts the operation frequency within a frequency range, such that the transmission unit generates radar beams having different dip angles. The receiving unit is electrically connected with the processing unit. The radar beam, after being reflected, is received by the receiving unit, and a feedback signal is generated. The processing unit receives the feedback signal, and selects an operation frequency of a predetermined energy. Therefore, the dip angle of the radar beam generated by the transmission unit is calibrated.

In an embodiment of the present invention, an angularly adjustable radar is provided, comprising a processing unit, and a transmission unit electrically connected with the processing unit. The transmission unit generates a radar beam according to an operation frequency. The processing unit adjusts the operation frequency within a frequency range, such that the transmission unit generates radar beams having different dip angles. The transmission unit scans with the radar beams generated within the frequency range.

With such configuration, the processing unit adjusts the operation frequency of the transmission unit within the frequency range, such that the transmission unit scans with the radar beams generated according to different frequencies, and the feedback signals generated by the receiving unit are compared by the processing unit, so as to acquire the energies corresponding to each frequency within the frequency range. The frequency corresponding to the predetermined energy is deemed as optimal and therefore selected as the operation frequency according to which the transmission unit generates the radar beam. Therefore, when the radar beam generated by the transmission unit is reflected by a medium, by conducting the scanning process within the aforementioned frequency range, the dip angle at which the radar beam passes through the translucent body is efficiently calibrated to an optimal angle, achieving an efficiency angle calibration function.

### BRIEF DESCRIPTION OF THE DRAWINGS

FIG. 1 is a schematic view illustrating the detection operation in accordance with an embodiment of the present invention.

FIG. 2 is a structural block view of the system in accordance with an embodiment of the present invention.

FIG. 3 is a block view illustrating the radar beams having different dip angles being generated according to different frequencies.

FIG. 4 is a diagram illustrating the waveforms of the radar beams having different dip angles being generated according to different frequencies.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

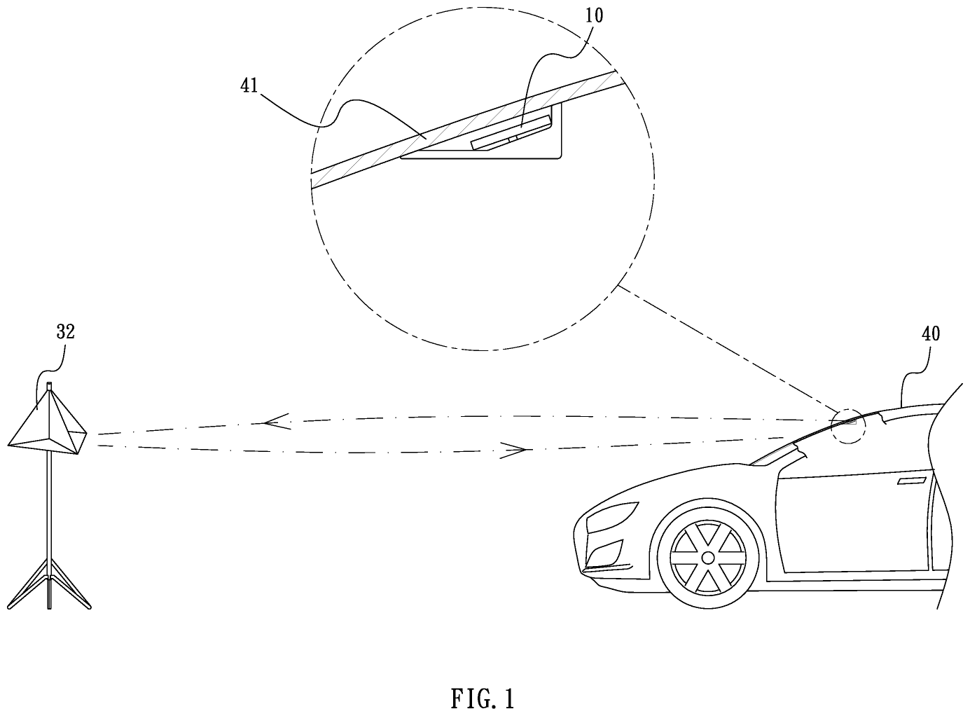

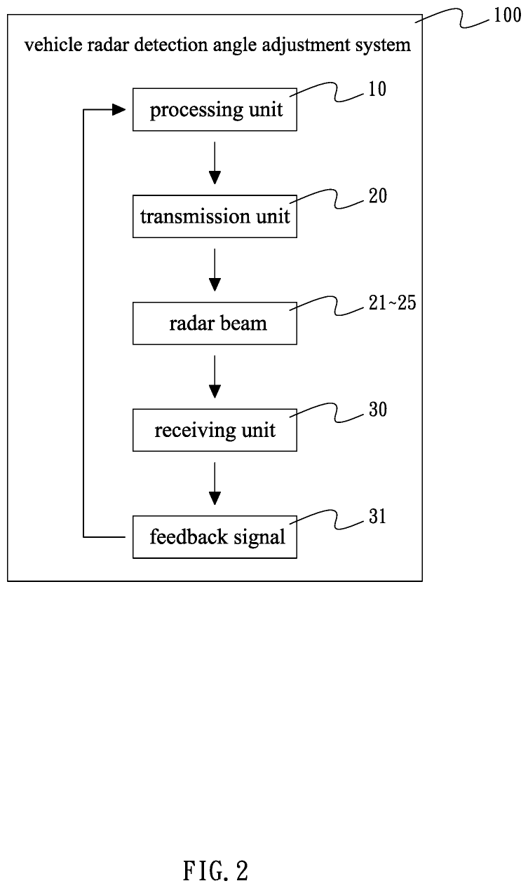

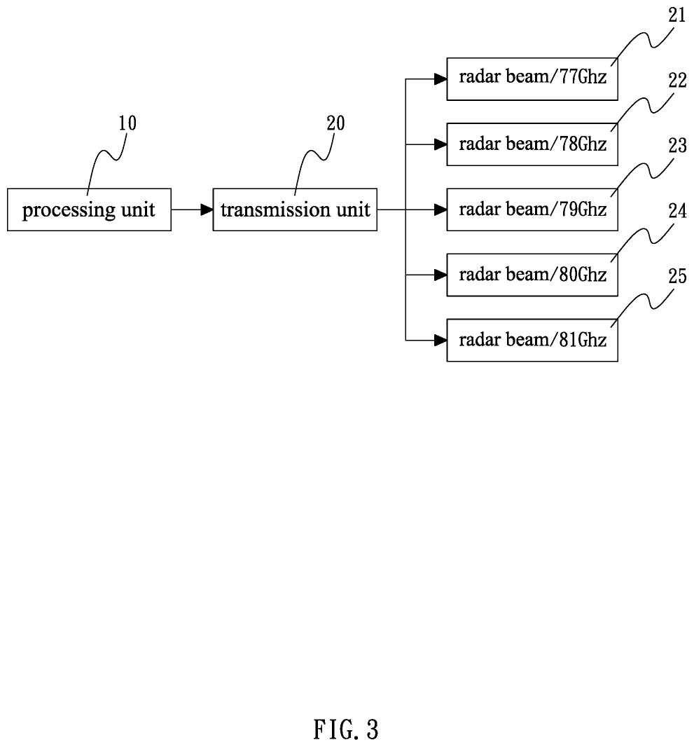

Referring to FIG. 1 to FIG. 4, a vehicle radar detection angle adjustment system 100 and the angularly adjustable radar thereof are provided, comprising a processing unit 10, a transmission unit 20, and a receiving unit 30.

The transmission unit 20 is disposed on the vehicle 40 and electrically connected with the processing unit 10. The transmission unit 20 generates and launches out a radar beam according to an operation frequency. In an embodiment of the present invention, the transmission unit 20 is a leaky-wave antenna, which is adhered to the inner side of the windshield 41 of the vehicle 40. Therefore, when being disposed on the vehicle 40, the transmission unit 20 in the embodiment is simply attached to the windshield 41. Such installation method is relative easier compared to the conventional mechanical adjustment method, achieving an efficient installation function.

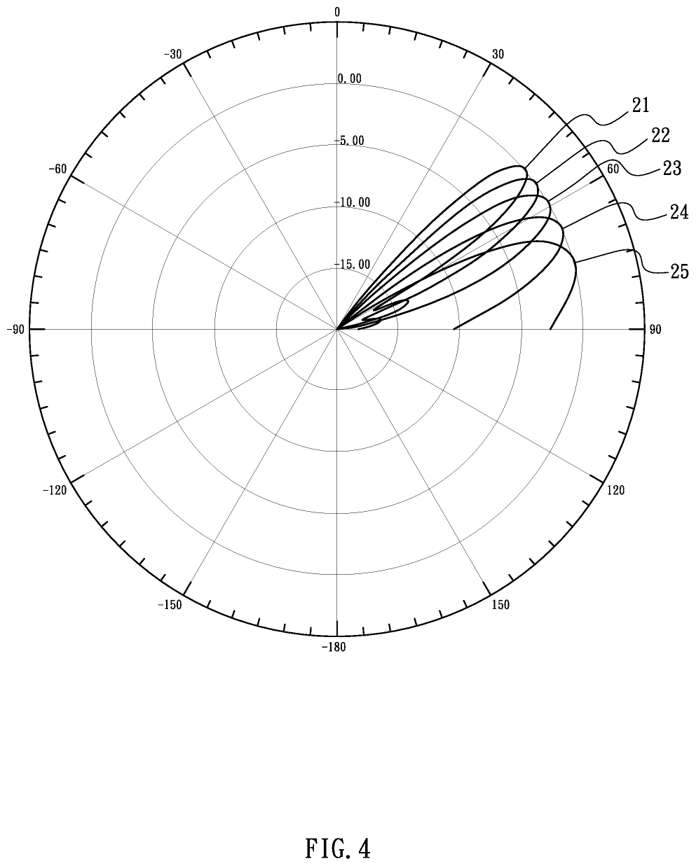

The processing unit 10 adjusts the operation frequency of the radar beam which is generated by the transmission unit 20 within a frequency range, so as to change the dip angle at which the radar beam passes through the windshield 41. In a preferred embodiment, the processing unit 10 and the transmission unit 20 form an angularly adjustable radar. Therefore, the transmission unit 20 scans with the radar beam generated according to the frequency adjusted by the processing unit 10. In an embodiment of the present invention, the frequency ranges between 77 GHz to 81 GHz. When the processing unit 10 adjusts the operation frequency of the radar beam generated by the transmission unit 20, the adjustment is orderly carried out at a frequency of, for example, 77 GHz, 78 GHz, 79 GHz, 80 GHz, and 81 GHz, respectively. In other words, the transmission unit 20 generates radar beams corresponding to the operation frequencies of 77 GHz, 78 GHz, 79 GHz, 80 GHz, and 81 GHz, respectively. As shown by FIG. 4, the transmission unit 20 in the embodiment generates the radar beam 21 at the operation frequency of 77 GHz, generates the radar beam 22 at the operation frequency of 78 GHz, generates the radar beam 23 at the operation frequency of 79 GHz, generates the radar beam 24 at the operation frequency of 80 GHz, and generates the radar beam 25 at the operation frequency of 81 GHz, respectively. Also, it is clearly seen that the dip angles of the radar beam 21 to radar beam 25 orderly become larger than the previous one.

The receiving unit 30 is electrically connected with the processing unit 10, so as to receive the reflected radar beam and accordingly generate a feedback signal 31. In an embodiment of the present invention, a reflector 32 is further comprised, which is a corner reflector in the embodiment and disposed in front of the vehicle 40. The reflector 32 faces the direction from which the transmission unit 20 launches out the radar beams 21 to 25. When the radar beams 21 to 25 are launched out to pass through the windshield 41, the radar beams 21 to 25 are reflected by the reflector 32 and received by the receiving unit 30, whereby the feedback signals 31 are generated, respectively.

The processing unit 10 receives the feedback signals 31 and compares the energy of the radar beams 21 to 25, and then select an operation frequency corresponding to the predetermined energy for calibrating the dip angle at which the radar beam is launched after passing through the windshield 41. The operation frequency corresponding to the predetermined energy, in the embodiment, is the operation frequency corresponding to one of the radar beams 21 to 25, received by the receiving unit 30, which has the largest amount of energy. In the embodiment, the radar beam 23 has the largest energy. Therefore, the radar beam 23 at the operation frequency of 79 GHz is selected for calibrating the dip angle at which the radar beam is launched after passing through the windshield 41. In the embodiment, the processing unit 10 is a digital signal processing (DSP), and the feedback signal 31 is mainly an analog signal. By use of the analog-digital signal conversion, the feedback signal 31 is converted into a digital signal to be received by the processing unit 10.

In the embodiment, as shown by FIG. 4, based on the fact that the radar beams 21 to 25 are launched to pass through the windshield 41 toward the front side of the vehicle 40, the transmission range is defined as a 180-degree range facing outward from the point where the transmission unit 20 is attached to the windshield 41, so as to save unnecessary transmission range. In a preferred embodiment, the transmission range is defined as a 90-degree range toward the ground from a vertical line extending outward from the position at where the transmission unit 20 is attached to the windshield 41.

With the foregoing configuration, the processing unit 10 adjusts the operation frequency of the transmission unit 20 within a given frequency range, and the transmission unit 20 conduct a scanning operation with the radar beams 21 to 25 generated according to different frequencies. Next, the receiving unit 30 generates feedback signals 31 that are compared by the processing unit 10, such that the processing unit 10 selects the operation frequency corresponding to one of the radar beams 21 to 25 which has the predetermined energy amount (such as the operation frequency of 79 GHz having the largest energy), wherein the selected operation frequency is applied for the transmission unit 20 to generate the radar beam. Thus, when the radar beam generated by the transmission unit 20 passes through the windshield 41 and is refracted, through the efficiently carried out scanning operation of the processing unit 10 within the frequency range, one of the radar beams 21 to 25 having the most optimal dip angle at which the radar beam is launched after passing through the windshield 41 is acquired. Compared to the conventional mechanical adjustment method, the present invention enhances the calibration speed and achieves an improved calibration efficiency.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A vehicle radar detection angle adjustment system which is disposed in a vehicle, comprising:
a processing unit;
a transmission unit electrically connected with the processing unit, the transmission unit generating a radar beam according to an operation frequency, the processing unit adjusting the operation frequencies within a frequency range, such that the transmission unit generates radar beams at various dip angles corresponding to different operation frequencies; and
a receiving unit electrically connected with the processing unit and receiving the radar beams.

2. The adjustment system of claim 1, wherein the receiving unit, after receiving the radar beams, generates feedback signals corresponding to the radar beams, respectively, and the processing unit receives the feedback signals and selects one of the operation frequencies having a predetermined energy, so as to adjust and fix the dip angle by which the transmission unit sends out the radar beam.

3. The adjustment system of claim 1, wherein the transmission unit is attached to an inner side of a windshield of the vehicle.

4. The adjustment system of claim 3, wherein a transmission range of the radar beam is defined as a 180-degree range facing outward from a point where the transmission unit is attached to the windshield.

5. The adjustment system of claim 3, wherein the transmission range of the radar beam is defined as a 90-degree range toward the ground from a vertical line extending outward from the position at where the transmission unit is attached to the windshield.

6. The adjustment system of claim 1, wherein the operation frequency having the predetermined energy is the operation frequency having a largest energy.

7. The adjustment system of claim 1, wherein the frequency range is from 77 GHz to 81 GHz.

8. The adjustment system of claim 1, further comprising a reflector disposed outside of the vehicle, the radar beam generated by the transmission unit being reflected by the reflector and received by the receiving unit.

9. The adjustment system of claim 1, wherein the reflector is a corner reflector.

10. An angularly adjustable radar, comprising:
a processing unit; and
a transmission unit electrically connected with the processing unit, the transmission unit generating a radar beam according to an operation frequency, the processing unit adjusting the operation frequency within a frequency range, such that the transmission unit generates the radar beam at various dip angles;
the transmission unit scans with the radar beam generated according to the operation frequency ranging between the frequency range.

11. The radar of claim 10, wherein the transmission unit is a leaky-wave antenna.

12. The radar of claim 10, wherein the frequency range is from 77 GHz to 81 GHz.

13. The radar of claim 10, wherein the transmission unit is attached to an inner side of a windshield of the vehicle.

14. The radar of claim 13, wherein a transmission range of the radar beam is defined as a 180-degree range facing outward from a point where the transmission unit is attached to the windshield.

15. The radar of claim 13, wherein the transmission range of the radar beam is defined as a 90-degree range toward the ground from a vertical line extending outward from the position at where the transmission unit is attached to the windshield.
